(19) United States
(12) Patent Application Publication
(10) Pub. No.: US 2015/0296307 A1
(43) Pub. Date: Oct. 15, 2015

(54) DUAL DIAPHRAGM AND DUAL BACK PLATE ACOUSTIC APPARATUS

(71) Applicant: Knowles Electronics, LLC., Itasca, IL (US)

(72) Inventors: Ning Shao, Bartlett, IL (US); Eric J. Lautenschlager, Geneva, IL (US)

(21) Appl. No.: 14/669,843

(22) Filed: Mar. 26, 2015

Related U.S. Application Data
(60) Provisional application No. 61/977,875, filed on Apr. 10, 2014.

(51) Int. Cl. H04R 23/00; H04R 7/16

(52) U.S. Cl. CPC H04R 23/00; H04R 7/16; H04R 2201/003

(57) ABSTRACT

A microelectromechanical system (MEMS) die includes a back plate and a diaphragm assembly. The back plate includes a first back plate portion including a first electrode and a second back plate portion including a second electrode, both electrodes being integrated on a mechanical supporting layer. The diaphragm assembly includes a first diaphragm disposed proximate to and in spaced apart relation from the first back plate portion, with the first diaphragm defining an opening therethrough. The diaphragm assembly also includes a second diaphragm disposed proximate to and in spaced apart relation from the second back plate portion, the second diaphragm disposed within the opening and separated from the first diaphragm by a ring-shaped void. The diaphragm assembly also includes a connection portion connecting the first diaphragm and the second diaphragm and extending through the ring-shaped void.

### CROSS REFERENCE TO RELATED APPLICATION

This application which claims the benefit of U.S. Provisional Application No. 61/977,875 entitled “Dual Diaphragm and Dual Back Plate Acoustic Apparatus” filed Apr. 10, 2014, the contents of which are incorporated herein by reference in its entirety.

### TECHNICAL FIELD

This application relates to acoustic devices and, more specifically, to the configurations of the back plates and diaphragms that are used in these devices.

### BACKGROUND OF THE INVENTION

Various types of acoustic devices have been used over the years. One example of an acoustic device is a microphone. Generally speaking, a microphone converts sound waves into an electrical signal. Microphones sometimes include multiple components that include micro-electro-mechanical systems (MEMS) and integrated circuits (e.g., application specific integrated circuits (ASICs)). A MEMS die typical has disposed on it a diaphragm and a back plate. Changes in sound energy move the diaphragm, which changes the capacitance involving the back plate thereby creating an electrical signal. The MEMS dies is typically disposed on a base or substrate along with the ASIC and then both are enclosed by a lid or cover.

The MEMS devices need to operate in a variety of different conditions and applications. Different characteristics are used to describe the operating performance of microphones such as the signal-to-noise ratio (SNR). For instance, it is typically desirable to have microphones with a high SNR. The total harmonic distortion (THD) is another measure of microphone performance. It is typically desirable to have a microphone that has a low THD.

Previous microphones have been generally unable to provide performance characteristics that include as both a high SNR and a low THD. This has resulted in some user dissatisfaction with these previous approaches and devices.

### BRIEF DESCRIPTION OF THE DRAWINGS

For a more complete understanding of the disclosure, reference should be made to the following detailed description and accompanying drawings wherein:

FIG. 1 comprises a perspective diagram of a MEMS microphone with a dual diaphragm and a dual back plate according to various embodiments of the present invention;

FIG. 2 comprises a side cut-away diagram of a MEMS microphone with a dual diaphragm and a dual back plate according to various embodiments of the present invention;

FIG. 3 comprises a perspective diagram of a dual diaphragm and a dual back plate that is used in a MEMS microphone according to various embodiments of the present invention;

FIG. 4 comprises a side cut-away diagram of a dual diaphragm and a dual back plate that is used in a MEMS microphone according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

MEMS devices are provided that have two diaphragms and two back plates all disposed in and forming a single MEMS motor element. In these regards, one diaphragm-back plate pair in the single motor is optimized to provide adequate signal-to-noise ratio (SNR) and the other diaphragm-back plate pair is optimized for low THD performance under a high sound pressure level environment.

In many of these embodiments, a microelectromechanical system (MEMS) die includes a back plate. The back plate includes a first back plate portion including a first electrode, and a second back plate portion including a second electrode. Both the first electrode and the second electrode are integrated on a mechanical supporting layer. The MEMS die also includes a diaphragm assembly. The diaphragm assembly includes a first diaphragm disposed proximate to and in spaced apart relation from the first back plate portion, and the first diaphragm defines an opening therethrough; a second diaphragm disposed proximate to and in spaced apart relation from the second back plate portion, and the second diaphragm is disposed within the opening and separated from the first diaphragm by a ring-shaped void; and a connection portion connecting the first diaphragm and the second diaphragm and extending through the ring-shaped void. Movement of the first diaphragm is effective to alter the electrical potential at the first back plate portion and not substantially alter the electrical potential at the second back plate. Movement of the second diaphragm is effective to alter the electrical potential at the second back plate portion and not substantially alter the electrical potential at the first back plate.

In some aspects, the second diaphragm is substantially concentric with the first diaphragm. In some examples, the mechanical supporting layer comprises a silicon nitride layer. In other examples, the first electrode comprises a poly-silicon layer. In still other examples, the second electrode comprises a poly-silicon layer.

In other aspects, the first diaphragm is relatively more flexible than the second diaphragm. In still other aspects, the back plate comprises a first plurality of posts forming an inner ring configuration and a second plurality of posts forming an outer ring configuration, the outer ring configuration being concentric with the inner ring configuration. In some examples, movement of the first diaphragm is restricted by the first plurality of posts, and movement of the second diaphragm is restricted by the second plurality of posts.

In other examples, the first electrode is at least partially disposed between two or more posts of the first plurality of posts. In some other examples, the second electrode is at least partially disposed on at least one post of the second plurality of posts.

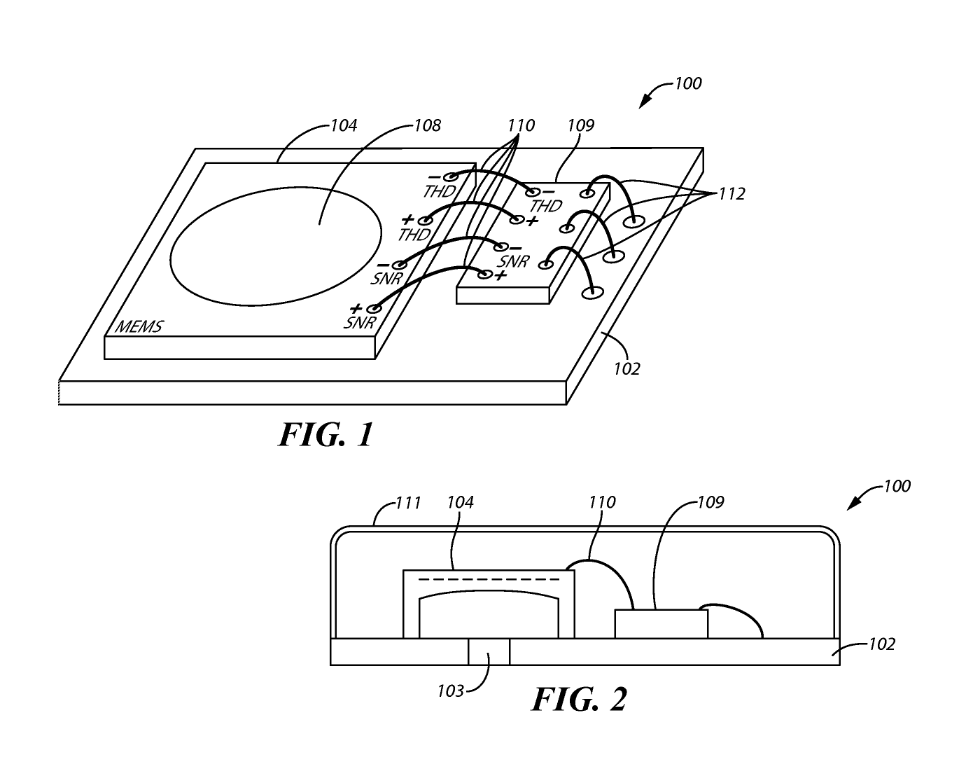

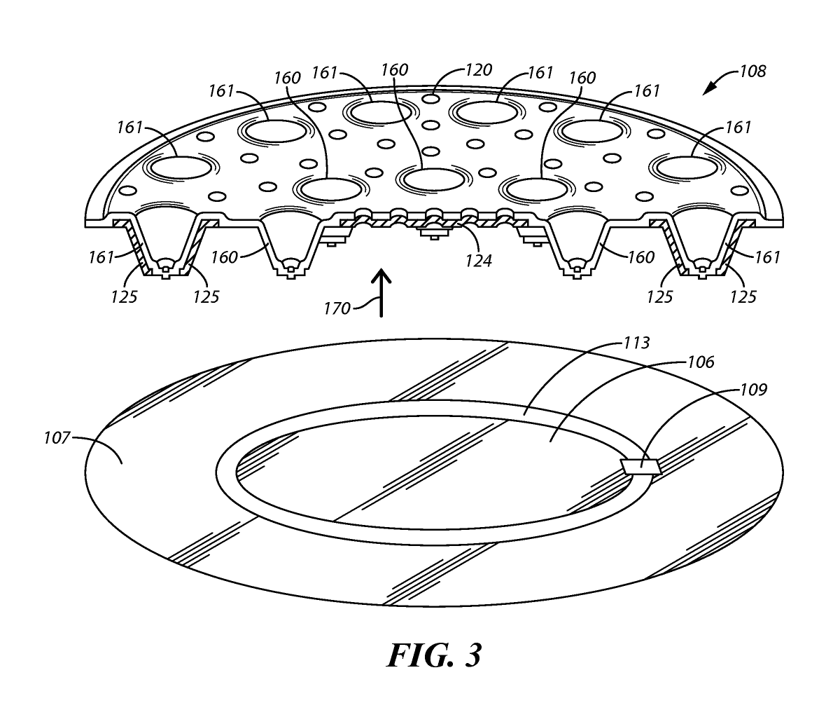

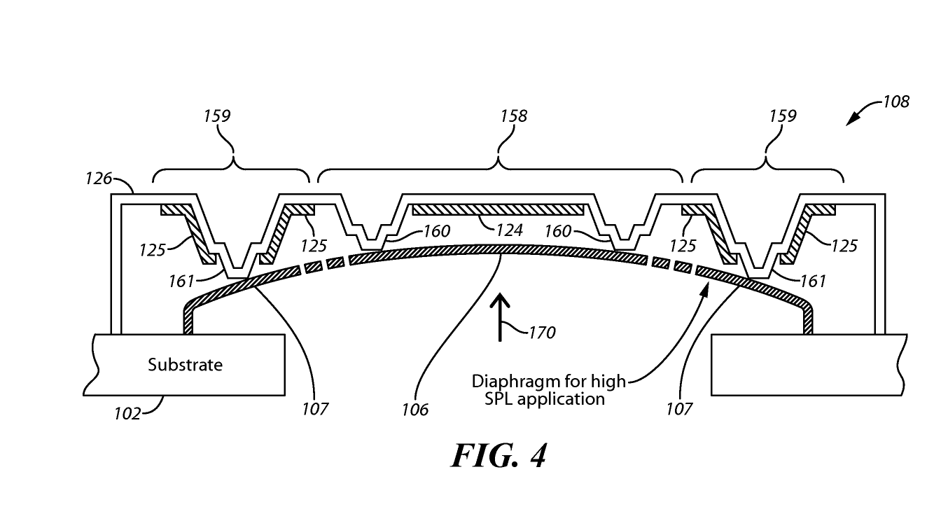

Referring now to FIG. 1, FIG. 2, FIG. 3, and FIG. 4, one example of a dual back plate/dual diaphragm MEMS motor and its use in a microphone is described. A microelectromechanical system (MEMS) microphone 100 includes a substrate 102. The substrate 102 may be any type of base such as a printed circuit board. Other examples of substrates are possible.

Disposed on the substrate 102 is a MEMS die 104. The MEMS die 104 includes a first diaphragm 106 and a second diaphragm 107 that are connected by a tab 109. The tab 109 is a single tab that is used to connect the two diaphragms. An empty ring (of space) 113 is disposed between the diaphragms 106 and 107. The MEMS die 104 also includes a back plate 108 that includes a first back plate portion 158 and a second back plate portion 159. Together, the diaphragm portions and the back plate portions form a single MEMS motor. Sound enters the microphone 100 via a port 103, which extends through the substrate 102. Alternatively, the port 103 may extend through a lid or cover 111 that covers the substrate 102 and the elements that are disposed on the substrate 102.

The first diaphragm 106 is an inner diaphragm that has an operation and movement governed and controlled by an inner ring of posts 160 on the back plate. The diaphragm portion 106 serves for high SNR applications such as far-field voice recognition and high fidelity recording. Since it is linked only at one point to the second diaphragm 107 at tab 109, it is a floating ring design. The second diaphragm 107 is an outer diaphragm that has an operation and movement governed and controlled by a second ring of posts 161 and serves for low THD applications such as high sound level recording with low distortion and wind noise reduction.

In these regards, when the first diaphragm moves upward in the direction indicated by the arrow labeled 170, the first diaphragm 106 bumps into and has its movement restricted by the posts 160. Similarly, when the second diaphragm 107 moves upward in the direction indicated by the arrow labeled 170, the second diaphragm bumps into and has its movement restricted by the posts 161. The posts 160 and 161 are arranged in a circular configuration in two concentric rings around the back plate 108.

The back plate 108 includes a plurality of holes or openings 120. The purpose of the holes 120 is sound transmission, pressure relief, and/or pressure equalization.

The first back plate portion 158 of the back plate 108 includes a first poly-silicon layer (electrode) 124 for high SNR applications. The second back plate portion 159 of the back plate 108 includes a second poly-silicon layer (electrode) 125 for low THD applications. The layers 124 and 125 are electrodes that sense relative movement of the corresponding diaphragms 106 and 107. The back plate 108 also includes a silicon nitride layer 126.

As mentioned, the purpose of the first poly-silicon layer 124 and the poly-silicon layer 125 is to sense movement of the diaphragms 106 and 107 respectively. The purpose of the silicon nitride layer 126 is to provide mechanical support for the back plate 108.

The conductive portions of the back plate 108 are electrically charged. As the diaphragm portions 106 and 107 move, the electrical potential between the back plate 108 and the diaphragm portions 106 and 107 changes thereby creating an electrical signal. If sound moves the diaphragm portions 106 and 107, then the electrical signal is produced that representative of the sound.

An application specific integrated circuit (ASIC) 109 is also disposed on the substrate 102. The ASIC 109 may perform various signal processing functions, to mention one example of its use. The MEMS die 104 is coupled to the ASIC 108 by wires 110. The ASIC 108 is coupled to the substrate by wires 112.

In one example of the operation of the microphone 100, sound enters the port 103 and moves the diaphragms 106 or 107. Movement of the diaphragms 106 or 107 is detected by the first back plate portion 158 or second back plate portion 159, respectively. For each of these interactions, changes the capacitance involving the corresponding back plate portions and diaphragms to create an electrical signal. Generally speaking, there are two channels of outputs from the MEMS die 104. One channel, supported by diaphragm and back plate pair 159 and 107, is targeted for low THD performance. Another channel, supported by diaphragm and back plate pair 158 and 106, is targeted for high SNR performance. The electrical signal may be transmitted to the ASIC 109 via wires 110. The ASIC has the capability to switch between the two channels depends on performance requirements. After processing of the signal by the ASIC 109, the processed signal is sent over wires 112, which couple to pads on the bottom of the substrate 102. A customer may couple other electronic devices to these pads. For example, the microphone 100 may be disposed in a cellular phone or a personal computer and appropriate circuitry from these devices may be coupled to the pads.

In operation, high SNR related performance requires the use of a relatively flexible diaphragm. This relatively flexible diaphragm is provided by the inner diaphragm 106 which is free to move across a greater range than the second diaphragm 107. To achieve a low THD performance under high sound pressure levels, a relatively stiff diaphragm is used. This is provided by the outer diaphragm 107, which has a more restricted region or amount of movement than the inner diaphragm 106. In this way, depending upon the application (e.g., sound pressure of the received sound), diaphragm operation can be varied and desired operational characteristics can be obtained.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microelectromechanical system (MEMS) die comprising:
a back plate comprising:
a first back plate portion including a first electrode; and
a second back plate portion including a second electrode; and both the first electrode and the second electrode are integrated on a mechanical supporting layer
a diaphragm assembly, the diaphragm assembly comprising:
a first diaphragm disposed proximate to and in spaced apart relation from the first back plate portion, the first diaphragm defining an opening therethrough;
a second diaphragm disposed proximate to and in spaced apart relation from the second back plate portion, the second diaphragm disposed within the opening and separated from the first diaphragm by a ring-shaped void; and
a connection portion connecting the first diaphragm and the second diaphragm and extending through the ring-shaped void;
wherein movement of the first diaphragm is effective to alter the electrical potential at the first back plate portion and not substantially alter the electrical potential at the second back plate; and
wherein movement of the second diaphragm is effective to alter the electrical potential at the second back plate portion and not substantially alter the electrical potential at the first back plate.

2. The MEMS die of claim 1, wherein the second diaphragm is substantially concentric with the first diaphragm

3. The MEMS die of claim 1, wherein the mechanical supporting layer comprises a silicon nitride layer.

4. The MEMS die of claim 1, wherein the first electrode comprises a poly-silicon layer.

5. The MEMS die of claim 1, wherein the second electrode comprises a poly-silicon layer.

6. The MEMS die of claim 1, wherein the first diaphragm is relatively more flexible than the second diaphragm.

7. The MEMS die of claim 1, wherein the back plate comprises a first plurality of posts forming an inner ring configuration and a second plurality of posts forming an outer ring configuration, the outer ring configuration concentric with the inner ring configuration.

8. The MEMS die of claim 7, wherein movement of the first diaphragm is restricted by the first plurality of posts, and movement of the second diaphragm is restricted by the second plurality of posts.

9. The MEMS die of claim 7, wherein the first electrode is at least partially disposed between two or more posts of the first plurality of posts.

10. The MEMS die of claim 7, wherein the second electrode is at least partially disposed on at least one post of the second plurality of posts.
